(19) United States
(12) Patent Application Publication
(10) Pub. No.: US 2024/0313534 A1
(43) Pub. Date: Sep. 19, 2024

(54) SYSTEM AND METHOD FOR AUTOMATED ADJUSTMENT OF ENERGY USAGE

(71) Applicant: Enersponse Inc, Newport Beach, CA (US)

(72) Inventor: James Muraca, Newport (AU)

(73) Assignee: Enersponse Inc, Newport Beach, CA (US)

(21) Appl. No.: 18/607,208

(22) Filed: Mar. 15, 2024

Related U.S. Application Data
(60) Provisional application No. 63/452,825, filed on Mar. 17, 2023.

(51) Int. Cl. H02J 3/12; H02J 3/38

(52) U.S. Cl. CPC H02J 3/12; H02J 3/381; H02J 2203/10; H02J 2300/20; H02J 2310/52; H02J 2310/62

(57) ABSTRACT

Disclosed herein is a computerized method including operations of obtaining electrical grid metrics, obtaining electricity usage metrics from various sites, determining a clean response score indicative of a ratio of a total amount of carbon dioxide produced as a result of generation of electricity provided to the electrical grid and a percentage of the electricity supplied to the electrical grid that is generated using low CO₂ emissions resources, wherein low CO₂ emissions resources include renewable resources and nucelar resources, performing a threshold comparison operation with the clean response score to a threshold, and based on a result of the threshold comparison operation, automating the initiation of a curtailment strategy at a first site, which includes operations that reduce electricity usage at the first site. Automating the initiation of the curtailment strategy may include generating instructions that cause adjustment of the functioning of an electrical device to reduce electricity usage.

### CROSS-REFERENCE TO RELATED APPLICATIONS

This application claims the benefit of priority to the United States Provisional Patent Application titled, “SYSTEM AND METHOD FOR AUTOMATED ADJUSTMENT OF ENERGY USAGE,” filed on Mar. 17, 2023, and assigned Provisional Application No. 63/452,825, the entire contents of which is incorporated herein by reference.

### FIELD OF THE INVENTION

Briefly summarized, embodiments disclosed herein are directed to systems and methods for monitoring an energy grid and the energy usage of one or more buildings, and automatically adjusting the status of appliances energy-consuming components associated with the one or more buildings based on the status of the energy grid.

### BACKGROUND

As is known, the electric grid in the United States is a network of power plants, transmission lines, and distribution lines that transmit electricity to homes, businesses, and charging stations. Power plants generate electricity from numerous sources, including coal, natural gas, and renewable resources like wind and solar. The electricity generated at these power plants travels through high-voltage transmission lines to substations, which provide it to homes and businesses via distribution lines following transformation to lower voltages. Power lines connect individual homes and businesses to distribution lines and ultimately the electric grid. Meters are typically positioned at each home or business building to measure how much electricity is being consumed.

As consumption of electricity from the electric grid varies based on electricity demand, the electricity provided by the grid may be generated by varying sources. For instance, it may be preferable to provide electricity generated through renewable energy sources when possible as this generation is currently understood to be the most environmentally-friendly method. However, as demand increases in a particular region, such as during the afternoon of a heatwave, it may not be feasible to solely provide electricity to the grid from renewable energy-sources and other methods of generating electricity may be required such as through the burning of fossil fuels, which are considered less environmentally-friendly. When demand for electricity is met using electricity generated through resources that typically emit a “low” amount of carbon dioxide (CO₂) when used to generate electricity (“low CO₂ emission resources”), the grid may be referred to as being “clean.” Low CO₂ emission resources include, for example, renewable-energy sources and nuclear resources. Nuclear power plants may generate electricity through fission or fusion, which is used to produce steam and turn large turbines. Although electricity generation by nuclear power plants includes the use of non-renewable resources, such electricity generation does not emit CO₂ or other greenhouses, and is thus considered a low CO₂ emissions resource for purposes of this disclosure. However, as the demand for electricity increases and the grid becomes stressed to provide the required amount of electricity, the grid turns to electricity generated through burning of fossil fuels, which typically emits a “high” amount of CO₂ and the grid may be referred to as being “dirty.”

Power consumption on the electric grid is monitored using a combination of sensors and metering devices. Specifically, sensors are used to measure the amount of electricity flowing through transmission and distribution lines, while metering devices are used to measure the amount of electricity being used by individual homes, businesses, and charging stations. Utility companies monitor the output of the sensors and metering device, which enables a determination to be made as to when the grid is stressed and adjustments to be made regarding how to provide the grid with sufficient energy.

Electrical energy consumption continues to increase within the United States year-over-year. As temperatures become more extreme throughout the country, especially as the country sees increasingly warmer temperatures in the summer months, electrical energy consumption is becoming a cause of concern for homeowners, business owners, and politicians due to raising costs. Additionally, increased demand for electrical energy at a particular time may lead to power outages, which may last minutes, hours, or even days. Power outages may be an inconvenience to some but may be life-threatening to others when heating or cooling is unavailable. For instance, power outages in the summer months pose severe health risks to the elderly when cooling systems are unavailable.

Currently, there are systems that monitor the energy consumption from the electric grid and provide insights about energy consumption of a particular region, e.g., county, state, etc., to relevant authorities such as utility companies. However, merely monitoring energy consumption does not change the energy consumption practices or habits of homeowners and business owners to positively affect energy consumption at times when the electric grid is stressed (e.g., during times of increased energy consumption).

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 is graphical illustration of an electricity and the deployment of the clean response system therein, according to some embodiments;

FIG. 2 is a graphical illustration plotting a total amount of electrical power (MW) supplied by the electrical grid and the percentage of the total amount of supplied electrical power (MW) comprised of renewable energy generation, according to some embodiments;

FIG. 3A is a graphical illustration of a sample distribution of response events over the months of a calendar year, according to some embodiments;

FIG. 3B is a graphical illustration of a sample distribution of response events over the months of a calendar year by hour, according to some embodiments;

FIG. 4A is a graphical illustration showing a plot of pounds (lbs.) of CO₂ produced in supplying the electrical grid, the percentage of the total amount of supplied electrical power (MW) comprised of renewable energy generation, and clean response values, according to some embodiments;

FIG. 4B is a graphical illustration showing a plot of total lbs. of CO₂ produced, clean response values, and a threshold that when exceeded results in the triggering of a clean response event, according to some embodiments;

FIG. 5 is a graphical user interface illustrating an analytics overview of energy usage, according to some embodiments;

FIG. 6 is a flowchart illustrating a methodology of determining the occurrence of a triggering event and initiating automated adjustment of a site's electricity usage, according to some embodiments;

FIG. 7 is a flowchart illustrating a methodology of determining the occurrence of a triggering event, according to some embodiments;

FIG. 8 is a graphical user interface illustrating metrics of energy usage on a per company basis, according to some embodiments; and

FIG. 9 is a graphical user interface for receipt of user input directed to generating a new clean response event trigger of energy usage, according to some embodiments.

### DETAILED DESCRIPTION

Before some particular embodiments are disclosed in greater detail, it should be understood that the particular embodiments disclosed herein do not limit the scope of the concepts provided herein. It should also be understood that a particular embodiment disclosed herein can have features that can be readily separated from the particular embodiment and optionally combined with or substituted for features of any of a number of other embodiments disclosed herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “top,” “bottom,” “front,” “back,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise.

With respect to “proximal,” a “proximal portion” or a “proximal end portion” of, for example, a widget disclosed herein includes a portion of the widget intended to be near a user (e.g., a holder of the widget). Likewise, a “proximal length” of, for example, the widget includes a length of the widget intended to be near the user. A “proximal end” of, for example, the widget includes an end of the widget intended to be near the user. The proximal portion, the proximal end portion, or the proximal length of the widget can include the proximal end of the widget; however, the proximal portion, the proximal end portion, or the proximal length of the widget need not include the proximal end of the widget. That is, unless context suggests otherwise, the proximal portion, the proximal end portion, or the proximal length of the widget is not a terminal portion or terminal length of the widget.

With respect to “distal,” a “distal portion” or a “distal end portion” of, for example, a widget disclosed herein includes a portion of the widget intended to be opposite the user with respect to the proximal portion (e.g., “away” from the user). Likewise, a “distal length” of, for example, the widget includes a length of the widget intended to be opposite the proximal portion and away from the user. A “distal end” of, for example, the widget includes an end of the widget intended to be opposite the proximal end. The distal portion, the distal end portion, or the distal length of the widget can include the distal end of the widget; however, the distal portion, the distal end portion, or the distal length of the widget need not include the distal end of the widget. That is, unless context suggests otherwise, the distal portion, the distal end portion, or the distal length of the widget is not a terminal portion or terminal length of the widget.

The term “logic” may be representative of hardware, firmware or software that is configured to perform one or more functions. As hardware, the term logic may refer to or include circuitry having data processing and/or storage functionality. Examples of such circuitry may include, but are not limited or restricted to, a hardware processor (e.g., microprocessor, one or more processor cores, a digital signal processor, a programmable gate array, a microcontroller, an application specific integrated circuit “ASIC”, etc.), a semiconductor memory, or combinatorial elements.

Additionally, or in the alternative, the term logic may refer to or include software such as one or more processes, one or more instances, Application Programming Interface(s) (API), subroutine(s), function(s), applet(s), servlet(s), routine(s), source code, object code, shared library/dynamic link library (dll), or even one or more instructions. This software may be stored in any type of a suitable non-transitory storage medium, or transitory storage medium (e.g., electrical, optical, acoustical, or other form of propagated signals such as carrier waves, infrared signals, or digital signals). Examples of a non-transitory storage medium may include, but are not limited or restricted to, a programmable circuit; non-persistent storage such as volatile memory (e.g., any type of random access memory “RAM”); or persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the logic may be stored in persistent storage.

As a brief summary, systems and methods disclosed here are directed to managing commercial and industrial (C&I) and residential locations (“sites” or “customer sites”) enrolled in utility and wholesale demand response and energy programs and connecting those sites to a distributed energy resource management system (DERMS). In some embodiments, a “site” may refer to a location associated with an electrical meter box. Other illustrative examples of a site include an agriculture location (e.g., farm, warehouse, storage shed), a water treatment plant, or a waste treatment plant. Some embodiments of systems and methods disclosed herein are directed to providing energy utilization instructions to hundreds or thousands of sites, which each may have relatively low peak kilowatt (kW) per site usage, but in aggregate across hundreds or thousands of sites, the cumulative usage reflects several megawatts (MWs) of usage. When the energy usage of hundreds or thousands of sites is reduced through the disclosed systems and methods, the reduction is a meaningful, positive impact to the electric grid. Systems and methods disclosed herein may be utilized to manage multiple customer sites (e.g., tens, hundreds, thousands, etc.) that, in aggregate, correspond to multiple gigawatts (GWs) (e.g., 1, 2, 3, etc., GWs) of energy load under management.

The disclosed systems and methods may include integration with numerous types of residential and C&I technology providers, demand response providers, and utility companies, to optimize load shifting capabilities using one or more DERMS. By connecting a system (e.g., a platform described herein) that implements the methods disclosed herein to control and technology partners, the platform is able to automate dispatches for single sites as well as aggregated resources to give certainty to energy load curtailment and automated adjustment of site usage.

In the utility industry, utility companies implement demand response programs that involve usage rate increases, the provision of credits, or the provision of other incentives to customers based on energy usage of a customer site to control the energy demand on the electrical grid. These demand response programs are typically implemented when electricity demand outpaces or threatens to outpace the electricity supply. These programs are typically implemented prior to and/or during extreme weather such as during summer months when extremely high temperatures are anticipated/occurring. Times when these programs are implemented are typically referred to as any of demand response events, energy savings events, conservation events, or peak events. Thus, for example, as the electricity grid becomes congested (e.g., demand is increasing), a demand response may be initiated causing the cost of electricity to increase during a specified time period (e.g., the afternoon hours of a hot summer day) and credits to offered to customers that reduce their energy usage during those times, which ultimately results in cost-savings.

In some embodiments, systems and methods disclosed herein may signal demand response events to sites as indicated by a utility company based on the supply and demand of electricity at a given time. The determination to initiate a demand response events may be based on the price of electricity exceeding a particular threshold, which is determined by the demand/supply of electricity. In such embodiments, systems and methods disclosed herein may receive an indication from a utility company that a demand response event is to be initiated and subsequently transmit instructions to one or more sites causing initiation of a demand response event, which may result in the reduction of energy used by a site for a predetermined period of time.

Additionally, and importantly, systems and methods disclosed herein may determine that reduction of a site's energy usage would be advantageous prior to, in accordance with, or following a demand response event indicated by a utility company based on based on metrics other than the price of electricity, such as when the total amount of CO₂ produced in supplying electricity utilized by the electrical grid is higher than normal. In addition to providing cost savings when a site's usage of electricity is reduced, the site's usage of electricity produced by non-renewable energy generation sources is also reduced, resulting in a reduction of the amount of CO₂ produced that is assigned to a site. This may allow a site to achieve corporate social responsibility objectives related to energy conservation. As will be discussed below, the clean response system (or subsystem) performs operations to obtain certain information pertaining to the total amount of electricity being utilized, the amount of renewable and non-renewable energy utilized in producing the total amount of electricity being utilized, and the amount of CO₂ produced in providing the total amount of electricity being utilized to determine when a “clean response event” is to be triggered or initiated.

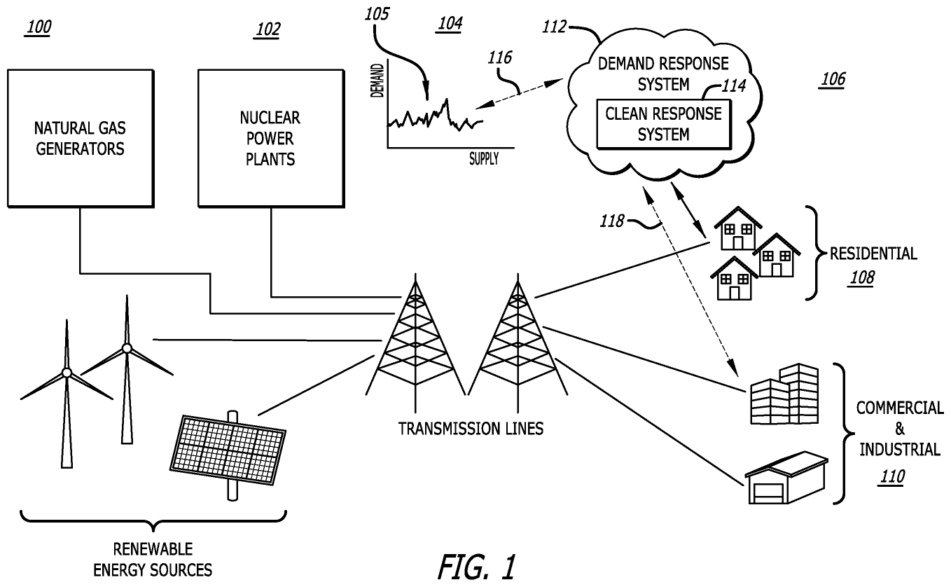

Referring now to FIG. 1, a graphical illustration of an electrical grid and deployment of the clean response system therein is shown according to some embodiments. FIG. 1 illustrates an electrical grid diagram 100 representing a connected network of energy-generation resources, transmission lines and substations, and energy-consuming sites. The electrical grid may also commonly be referred to as a utility grid or power grid. The diagram 100 includes a plurality of energy-generation resources 102 such as natural gas generators, coal power plants, wind turbines, and solar panels. It should be understood that these are merely examples and not inclusive of all energy-generation resources. As should also be understood, some resources may be referred to as “non-renewable resources” such as coal power plants and natural gas generators. Other resources may be referred to as “renewable resources” such as wind turbines and solar panels. The use of renewable resources to generate electricity is generally accepted as being a more environmentally-friendly method of generating power. As noted above, the distinction between renewable and non-renewable resources fails to consider the emission of CO₂ during the generation of electricity. Thus, the electricity grid is referred to as being “clean” when demand for electricity is met using electricity generated using low CO₂ emission resources, while the grid is referred to as being “dirty” when electricity generated using high CO₂ emission resources is utilized.

The diagram 100 further illustrates that the power generated by the resources 102 is transmitted to substations via transmission lines, where the electricity is converted from a high-voltage to a lower-voltage and then distributed to various energy-consuming sites 106 such as residential sites 108 and C&I sites 110. The substations and transmission lines are collectively illustrated by the transmission lines 104. The supply and demand of electricity may be measured as it is transmitted from the power generation resources 102 to the residential sites 108 and the C&I sites 110 (represented by the graphical representation 105 plotting supply v. demand).

The demand response system 112 may be integrated into the electrical grid through communicatively coupling to utility companies that own and monitor transmission lines and substations 104 and energy-consuming sites 108, 110 resulting in obtaining electrical grid data 116. The demand response system 112 is an energy resource management platform that integrates with utility (e.g., electricity) providers to aggregate their distributed energy resource (DER) and rebate programs across energy-using sites 106 to maximize financial incentives by automating load reduction responses. This process helps utility providers maintain a stable electrical grid, save utility customers money while also earning them passive income through rebates from the utility providers, and achieve corporate social responsibility objectives. The demand response system 112 may be connected to hundreds or thousands of power generators across North America, all dispatchable to customers' existing control systems. The demand response system 112 monitors energy-usage at a site specific level as well as weather patterns, system outages, and energy pricing fluctuations. The data obtained through this monitoring (116, 118) is then analyzed and synced with pre-set site preferences to automate adjustment of power usage in real-time (e.g., without the need for human intervention) at particular sites 106.

In some instances, the demand response system 112 may implement the methods disclosed herein through communicatively connecting with a customer site 106 at a device level, e.g., connected to devices such as thermostats, Heating, Ventilation, and Air Conditioning (HVAC) systems, dishwashers, washer/dryers, refrigerators, light bulbs, EV chargers, water pumps, waste water treatment plans, manufacturing facilities (e.g., paper mills, metal smelters, forges), agriculture farms, cold storage units or facilities, etc., which allows for controlling and programming detailed load management. In other embodiments, the demand response system 112 may be communicatively coupled to a site's utility meter. Certain events such as the occurrence particular grid metric measurements may result in adjustment of the usage by certain residential or commercial sites, which may result in the automated adjustment of the usage of certain devices at particular residential or commercial sites.

The clean response system 114, which in some embodiments, is directed to reducing usage of energy of a site 108, 110 produced by non-renewable resources by initiating “clean response events” that are triggered based on threshold comparisons using metrics such as real-time CO₂ produced in generating the electricity demand (“CO₂ output”) and real-time electricity produced through renewable resources. Additionally, the clean response system 114 may also be directed to increasing a site's energy usage when the CO₂ output is below a defined threshold. For instance, the clean response system 114 may instruct a site to precool a building when a high percentage of the energy supplied by the electrical grid is generated by renewable energy resources (“inverse clean response events”). The intent of an inverse clean response event is to increase the usage of electricity when CO₂ output is low to preempt the need to increase electricity using usage when CO₂ output increases. An inverse clean response event may be referred to as a preemptive response event.

It should be understood that the CO₂ assigned to a site based on its electricity usage may be reduced by merely reducing its electricity usage at any time of the day. However, the clean response system 114 analyzes metrics such as CO₂ output and real-time electricity produced through renewable resources to determine particular timeframes when a ratio comprising these two metrics is above a predetermined threshold, which is when the electrical grid is overly reliant on non-renewable energy sources to produce electricity required to meet the demand on the electrical grid. In some instances, implementation of clean response events to reduce energy usage may be used in place of an intermittent peaking plan or the like.

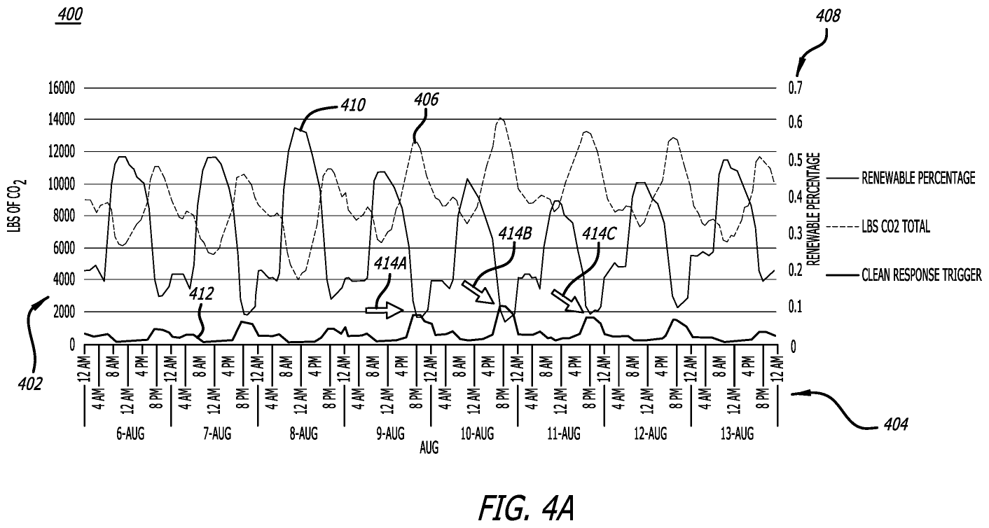

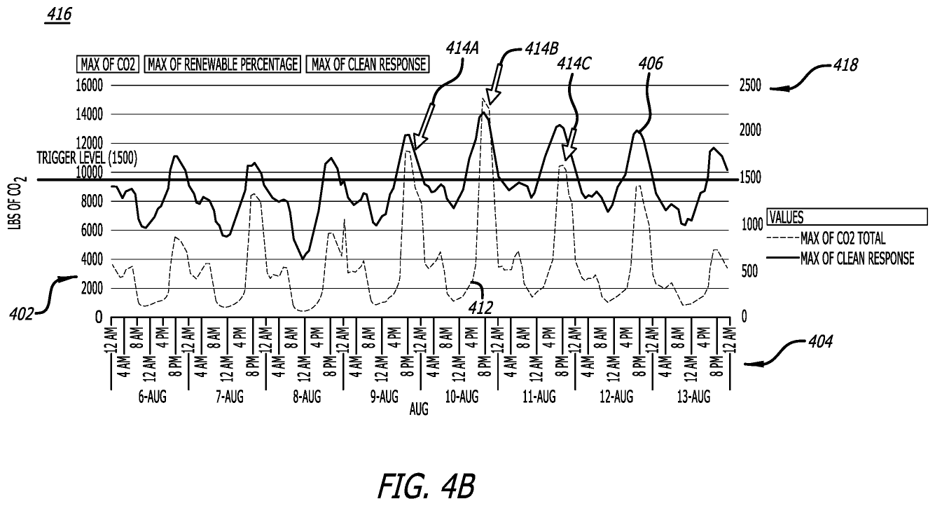

As will be discussed below and may be seen in FIG. 4A, the macro relationship between CO₂ output and the percentage of electricity provided to the electrical grid produced by renewable resources as a percentage is largely an inverse relationship. That is, CO₂ output is typically highest in the afternoon, and renewable resources as a percentage of total electricity generation is highest during the daytime (e.g., due to solar generation).

Thus, the clean response system 114 initiates clean response events to exploit timeframes where the CO₂ output is not inverse (see FIG. 4A). These timeframes are typically around sunrise or sunset such as when solar output is reduced as the sun is setting/down, wind is minimal, and CO₂ output is very high as air conditioning units are run to cool homes and other residential appliances are being utilized when individuals return home or otherwise stop working for the day.

When a clean response event trigger occurs (discussed below), the clean response system 114 creates a set of instructions 118 that are transmitted to a site, and the instructions 118, when executed by one or more processors, cause one or more appliances connected to the site's utility box to implement particular actions to reduce energy usage (collectively, a site's “curtailment strategy”). In some embodiments, transmission of the instructions 118 occurs via a network (e.g., the internet) according to one or more public and/or private application programming interfaces (APIs). Actions implemented may vary according to site, according to the appliances operating at the site, and/or the purpose served by the site. For example, the actions forming the curtailment strategy of a residential site may include dimming of lights, turning off outdoor lights, decreasing the maximum water temperature, and/or increasing the temperature to which an air conditioning unit is set. Referring to a C&I site, the actions forming the curtailment strategy may also include actions such as automatically turning off or dimming parking lot lighting, pausing deep freeze cycles at supermarkets, reducing the speed of a variable speed drive in a water pump, turning off booster pumps in a water network to utilize water gravity fed from an elevated reservoir, adjusting HVAC setpoints to deactivate cooling cycles, etc.

As will be discussed further below, a clean response event trigger may include an instance when a metric as determined by the clean response system 114 meets or exceeds a particular threshold (e.g., the occurrence of a clean response event trigger is based on the result of a threshold comparison). In some instances, the threshold may represent a ratio of CO₂ output to electricity supplied to the electrical grid produced by renewable resources. The threshold may be dynamically adjustable to alter the frequency of the occurrence of the clean response event triggers. For example, increasing the threshold may reduce the frequency of triggering instances (e.g., higher CO₂ output and/or lower percentage of electricity provided by renewable resources). Oppositely, decreasing the threshold may increase the frequency of triggering instances.

In embodiments, each response event has a start time, a duration (or an end time) and a site curtailment strategy, where the site curtailment strategy may be handled entirely or in part by a supervisory control and data acquisition (SCADA) control system, an energy management system (EMS), or a building management system (BMS). A SCADA control system enables supervision of machines and processes through a network of computing devices, which may include internet of things (IoT) sensors, control and/or monitoring devices, and low-level devices such as programmable logic controllers configurated to interface with equipment or machinery (e.g., conveyor belts, water pumps, HVAC units, generators, parking lot lights, etc.).

Additionally, response event instructions 118 transmitted to a site 106 (e.g., a site's SCADA control system, EMS, or BMS) may also include operations that occur prior to enactment of a demand, clean, and/or inverse clean response events (collectively, response events). For example, such operations may include a pre-cooling strategy for HVAC loads where the temperature of a building is decreased in anticipation of reducing energy usage in the near future. In some instances, such operations may include production of audible and visual alarms.

Once a response event has completed (e.g., a predetermined duration has expired such as 30 minutes, 1 hour, etc.), the demand response system 112 utilizes one or more APIs to receive utility meter data from a site 106 (where the utility meter data may also be represented by transmissions 118). This data may be used to determine the overall energy consumption for a site 106 during a given time period and may also be used to validate performance of a response event, e.g., illustrate how much energy was saved during the response event relative to a benchmark. With respect to clean response events, the data may be used to determine how much CO₂ was avoided by reducing the amount of energy utilized when the electrical grid was stressed (and thus when electricity supplied to the electrical grid was generated by non-renewable resources), e.g., in comparison to an amount of energy that was expected to be used without enactment of a site's curtailment strategy such as through comparison with historical data.

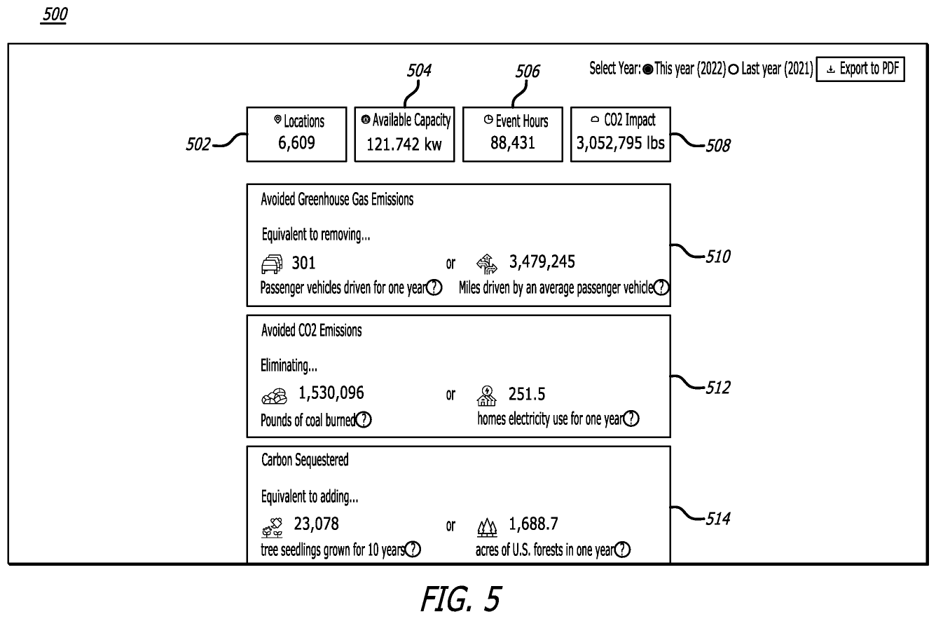

In some embodiments, the electricity savings and/or CO₂ per response event may be correlated with historical electricity usage and/or CO₂ emission data for a site during corresponding historical time frames such as prior day, prior week's average during the time frame, prior year's average during the time frame, etc. As a result, the demand response system may determine a “CO₂ reduction number” that may be provide to a site owner or administrator, e.g., via a report or dashboard (sec FIG. 5).

The intent of the clean response system 114 is to help curb reliance on electricity that is generated from non-renewable forms of energy like gas or coal. This is accomplished by monitoring the real-time carbon make-up of the electrical grid and, intelligently automating electricity usage loads on a site-by-site basis according to site-specific, pre-determined and customized specifications when CO₂ output meets or exceeds a particular threshold.

Specifically, the demand response system 112, and specifically, the clean response system 114, assists in increasing the speed at which the electrical grid transitions towards providing of energy that is generated by renewable resources. Additionally, the demand response system 112 stabilizes volatility that can arise during extreme weather events, which have significantly increased due climate change.

In some embodiments, the demand response system 112 communicatively connects to numerous sites 106, obtains energy usage data 118, and provides access to real-time data to owners or administrators in the form of reports or dashboards illustrating response events and how much CO₂ was avoided or reduced (see FIG. 5). In many instances, reports or dashboards for C&I sites may be aggregated such that administrators or owners may visual CO₂ was avoidance or reduction across all commonly-owned sites.

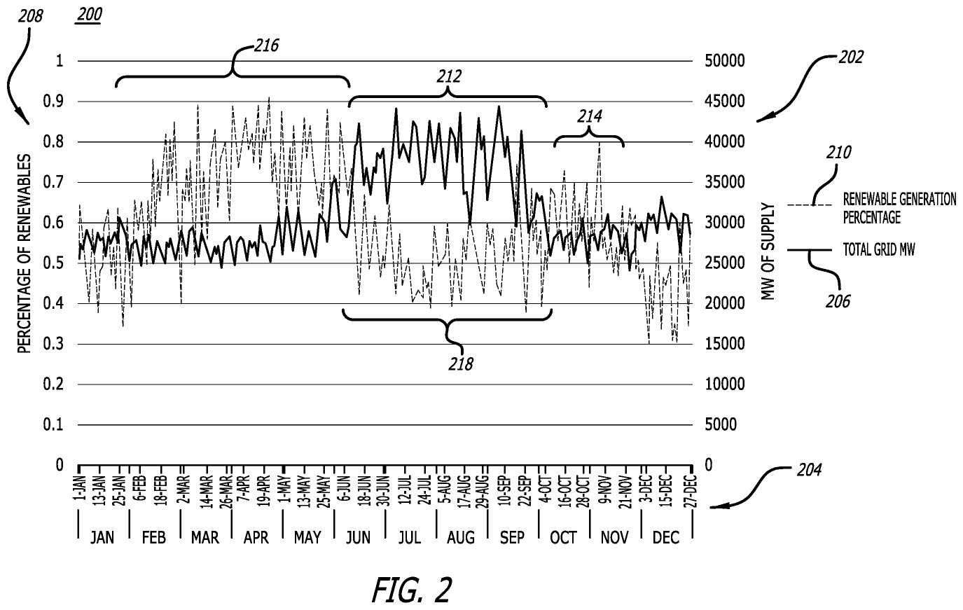

Referring now to FIG. 2, a graphical illustration plotting a total amount of electrical power (MW) supplied by the electrical grid and the percentage of the total amount of supplied electrical power (MW) comprised of renewable energy generation is shown according to some embodiments. The sample graph 200 provides an illustration of example but typical data plotting a total grid demand in milliwatts (MW) over time, which is represented by the plot line 206, with the y-axis on the right-hand side of the graph 200 (y-axis_{mw} 202) being supply of power in MW, and the x-axis 204 being time. Additionally, the graph 200 also provides an illustration of example but typical data plotting the percentage of electricity demand generated by renewable energy sources over time, which is represented by the plot line 210, with the y-axis on the left-hand side of the graph 200 (y-axis_{percentage} 208) being the percentage of electricity demand generated by renewable energy sources, and the x-axis 204 being time. The graph 200 illustrates the correlation between renewable generation and total grid MW over the course of a calendar year.

As is discussed throughout the disclosure, the clean response system 114 continuously monitors the electrical grid as well as the CO₂ output and the composition of resources (renewable and non-renewable) of each electricity region in North America. This monitoring enables the clean response system 114 to detect periods of stress on the electrical grid (e.g., when demand is trending toward or actually outpacing production of electricity by renewable energy sources). Through the correlation between renewable generation and total grid MW over the course of a calendar year, the graph 200 provides illustrative examples of grid stress, such as emphasized by block 212 (e.g., most of mid-June to mid-September).

As is further illustrated by the graph 200, the electrical grid is typically able to handle most of the demand in the fall, winter, and spring months with electricity generated by renewable resources such as solar, wind, nuclear, hydropower, etc. (e.g., mid-September to mid-June, see blocks 214, 216, which excludes late-November to late-December). However, the additional supply needed during summer months, especially on hot peak temperature days, is typically generated by non-renewable resources (e.g., goal burning), which leads to lower renewable generation as a percentage of the electricity supplied to the electrical grid at seen at block 218.

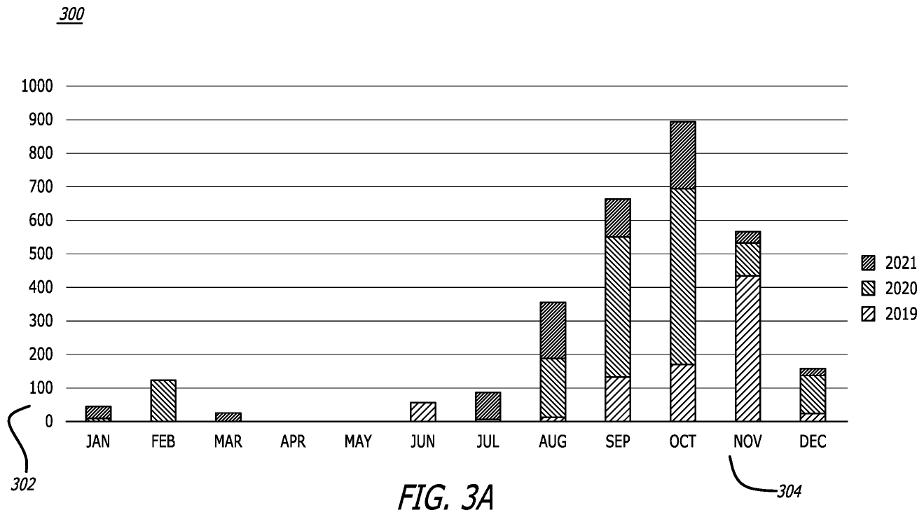

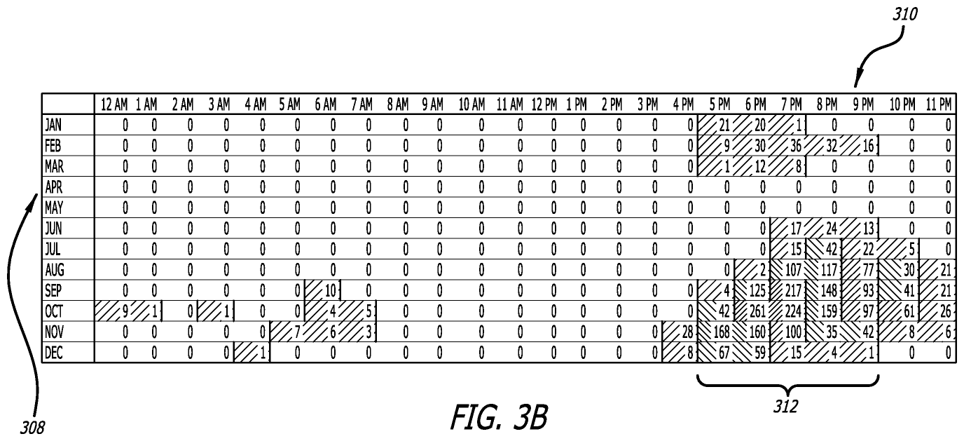

Referring to FIG. 3A, a graphical illustration of a sample distribution of response events over the months of a calendar year by hour is shown according to some embodiments. The graph 300 illustrates a bar for each month with a number of events portrayed along a y-axis 302 and the months of a calendar year portrayed along an x-axis 304. Graph 300 illustrates that response events primarily occur during the summer and fall months of August-November. Considering both FIGS. 2-3A, the two graphs illustrate that the number of response events correlates to the grid stress.

Referring now to FIG. 3B, a graphical illustration of a sample distribution of response events over the months of a calendar year by hour is shown according to some embodiments. The chart 306 illustrates a set of rows 308, where each row pertains to a month, and a set of columns 310, where each column pertains to an hour of a 24 hour day. Each cell within the chart represents a sample number of response events that occurred during a particular hour within a month (e.g., the sum of response events each day during that hour over the course of the particular month). As an illustrative example, the period of 5-9 pm during August-November resulted in the most response events, which indicates the grid is more stressed during this period, resulting in the use of non-renewable energy resources to generate electricity for the grid (e.g., plants that burn natural gas), and therefore “dirtying” the grid. It should be understood that this illustrative period is not intended to be a limiting factor of the inventive concepts described herein.

Thus, the chart 306 illustrates that most response events occur towards the afternoon and evening, which is typically when the sun begins to set or has done so, and the wind speed is less than during the late morning; however, buildings often utilize additional electricity during these times for heating/cooling, cooking, appliance use, etc.

Referring to FIG. 4A, a graphical illustration showing a plot of pounds (lbs.) of CO₂ produced in supplying the electrical grid, the percentage of the total amount of supplied electrical power (MW) comprised of renewable energy generation, and clean response values is shown according to some embodiments. The sample graph 400 illustrates provides an illustration of example data but typical data plotting a total amount of CO₂ (lbs.) over time, which is represented by the plot line 406, with the y-axis on the left-hand side of the graph 400 (y-axis_{CO2} 402) being lbs. of CO₂, and the x-axis 404 being time. Additionally, the graph 400 also provides an illustration of example but typical data plotting the percentage of electricity demand generated by renewable energy sources over time, which is represented by the plot line 410, with the y-axis on the right-hand side of the graph 400 (y-axis_{percentage} 408) being the percentage of electricity demand generated by renewable energy sources (0-0.7 indicating 0-70%), and the x-axis 404 being time. Thus, the graph 400 illustrates the generally inverse relationship between renewable generation and total lbs. of CO₂ used to supply the electricity demand over the course of a month.

Further, the graph 400 provides an illustration of a plot of the clean response values computed from the ratio of percentage of electricity demand generated by renewable energy sources and lbs. of CO₂ produced over time. The clean response values (in lbs. of CO₂) are represented by the plot line 412, using the same axes as the plot line 406. The plot line 412 illustrates numerous increase in value, such as in the evenings of August 7 and 9-12. Each of these increases may represent clean response events based on the threshold utilized. As is shown in FIG. 4B, the increase occurring on August 9-11 exceed a set threshold and are thus categorized as clean response events 414A, 414B, and 414C.

Generally, FIG. 4A illustrates that the macro relationship between CO₂ output and the percentage of electricity provided to the electrical grid produced by renewable resources as a percentage is largely an inverse relationship. That is, CO₂ output is typically highest in the afternoon, and renewable resources as a percentage of total electricity generation is highest during the daytime (e.g., due to solar generation).

Referring now to FIG. 4B, a graphical illustration showing a plot of total lbs. of CO₂ produced, clean response values, and a threshold that when exceeded results in the triggering of a clean response event in shown according to some embodiments. The graph 416 illustrates the plot lines 406, 412 of FIG. 4A, where the plot line 406 is shown over the y-axis on the left-hand side of the graph 400 (y-axis_{CO2} 402) being lbs. of CO₂, and the x-axis 404 being time.

Differently, FIG. 4B illustrates the plot line over the y-axis on the right-hand side of the graph 400 (y-axis_{CO2_right} 418) being lbs. of CO₂, and the x-axis 404 being time. The graph 416 illustrates the two plots 406, 412 over the same time axis 404 but at different scales of lbs. of CO₂. The graph 416 is intended to illustrate the alignment of the peaks of the plot 412 (clean response value being the ratio of lbs. of CO₂ to the percentage of electricity provided to the electrical grid produced by renewable resources) with the peaks of the plot 406 (lbs. of CO₂).

In FIG. 4B, a sample threshold level of 1500 lbs. of CO₂ is used (also referred to as a “trigger level”), which indicates that when the clean response value exceeds 1500 lbs. of CO₂, a clean response event is triggered. Of course, the clean response event may be triggered by meeting or exceeding the threshold and in some instances, manipulations may be performed on the numbers and ratios such that clean response values would need to be below the threshold in order to trigger a clean response event. Thus, generally stated, a clean response event may be triggered based on comparison of the clean response values to a threshold. As noted above, the threshold level may be dynamic and/or customizable by a system administrator. In some embodiments, the threshold level is consistent for all sites while in other embodiments, the threshold level may be site specific. In some embodiments, the threshold level may be specific to a group of sites (e.g., by type such as residential or C&I and/or by geographic region) or by sub-groupings of sites (e.g., type within a geographic region). In yet other embodiments, the threshold level may be determined in accordance with historical data, e.g., based on a previous time period such as 6 months, 1 year, 3 years, 5 years, etc., and expressed as a percentile from the maximum (e.g., 90%) so that the threshold level is configured to trigger a clean response when the clean response value is in upper 10% of the historical maximum for the selected time period.

In particular, FIGS. 4A-4B illustrate that the demand response system 112 is configured to obtain real-time CO₂ emissions data (e.g., amount of CO₂ per kwH) for a given geographical region, evaluate electrical grid data such as the composition of electricity provided by low CO₂ emission sources (or renewable resources) and by non-renewable resources to determine points of electrical grid composition when the percentage of electricity provided by low CO₂ emission sources is decreasing while demand is high (above a threshold amount). An example of such an occurrence may be during a hot summer day immediately following sunset so solar generation is low, however the demand on the electrical grid is high as millions of air conditioning units are running, which causes electricity to be generated through the use of high CO₂ emissions sources.

Referring to FIG. 5, a graphical user interface illustrating an analytics overview of energy usage is shown according to some embodiments. The graphical user interface (GUI) 500, or “dashboard” may be displayed on or by a network device such as on a computer monitor, a laptop screen, a mobile device screen, etc. In some embodiments, the dashboard 500 may be accessible via a web browser or may be accessible via a dedicated application that is downloaded to the networking device. The same dashboard 500 is shown to include a plurality of display portions, or display boxes, 502-514. The display boxes 502, 504, 506, and 508 may provide a number of locations (sites) connected to a specific account (e.g., a company may own several buildings each connected to an account where the energy usage and savings data may be aggregated in the dashboard 500), the available capacity for sites connected to the account, the total number of response event hours undertaken by the cites connected to the account, and the amount (e.g., lbs.) of CO₂ avoided as a result of the response events undertaken by the cites connected to the account, respectively.

In more detail and based on the illustrative example of FIG. 5, the display box 504 provides the available curtailable capacity aggregated across sites being monitored. That is, on average, each of the plurality of sites (e.g., 6,609 from display box 502) curtails 18.4 kW of energy during a response event (121, 172 kW divided by 6,609 sites). However, in reality, some sites will curtail more or less, e.g., one site could curtail 1000 kW per event and another may curtail only 1 kW. As one example, the pounds of CO₂ avoided during an response event may be calculated by utilizing an average of CO₂ avoided per kwH as determined by the United States Environmental Protection Agency (EPA). The duration of the event, the EPA average and the kW savings during a response event would be considered in determining an amount of CO₂ avoided (e.g., EPA average (e.g., 7.09×10⁻⁴) in metric tons CO₂/kwH multiplied by the kW saved during the response per hour multiplied by the number of hours of the response event). This amount of CO₂ avoided for a single response event may be aggregated over multiple events and filtered for display according to site, time (day, month, year, time of day, etc.), etc. It is noted that the EPA calculates a national weighted average of CO₂ avoided. This weighted national average may provide geographic specificity (e.g., CO₂ avoided in California may be different than in Missouri); thus, a more geographic specific calculation (and more accurate) may be performed using actual emissions provided by a particular state's electrical grid, such as the CO₂ avoided per kwH as determined by the California Independent System Operator (ISO) or New York ISO. Even more specifically, an ISO may provide a current CO₂ emissions rate, which may be updated at regular intervals (e.g., 1 minute, 10 minute, 15 minute, etc.). As a result, a determination of CO₂ avoided may be determined according to the stress on a specific state's electrical grid at a particular time of day. Thus, as an example, the specific CO₂ avoided on a hot summer day in California at 4:00 pm may be determined and reported (where using a national average or averaged CO₂ avoided calculated in another part of the US or world would not provide such an accurate determination). Additionally, the dashboard 500 may include a display portion 510 that illustrates an amount of avoided greenhouse gas emissions by comparing the savings in greenhouse gas emissions to the equivalent of removing (i) a number of passenger vehicles driven for a year, and/or (ii) a number of miles driven by an average passenger vehicle. The dashboard may also include a display portion 512 that illustrates an amount of CO₂ emissions avoided by comparing the savings in CO₂ emissions to the elimination of (i) a number of pounds of coal burned, and/or (ii) homes' electricity use for a year. Further, the dashboard may also include a display portion 514 that illustrates an amount of carbon sequestered by comparing carbon sequestered to the equivalent adding of (i) a number of tree seedlings grown for 10 years, and/or (ii) a number of acres of U.S. forests in one year.

In some embodiments, site owners/administrators are able to compare the usage of CO₂ avoided during response events to: an equivalent number of passenger cars removed from the road for a year; an equivalent pounds of burned coal; and an equivalent number of homes using an average amount of electricity per year. Further, a measure of the carbon sequestered during response events may be compared to a number of tree seedlings grown for 10 years or the number of acres of new forests planted in the U.S. annually.

As noted above, the reports and dashboards may be accessible by a web browser after providing authentication credentials and logging into an account that is associated with one or more sites. The data displayed on reports and dashboards may be filtered according to a plurality of parameters such as, but not limited or restricted to, site, year, month, day, hour, response event type, etc. In some embodiments, the reports may be downloaded and/or automatically transmitted to specified recipients such as via email at regular intervals (daily, weekly, monthly, annually, etc.). Additionally, alerts may be provided to owners and administrators when a response event is initiated or suggested.

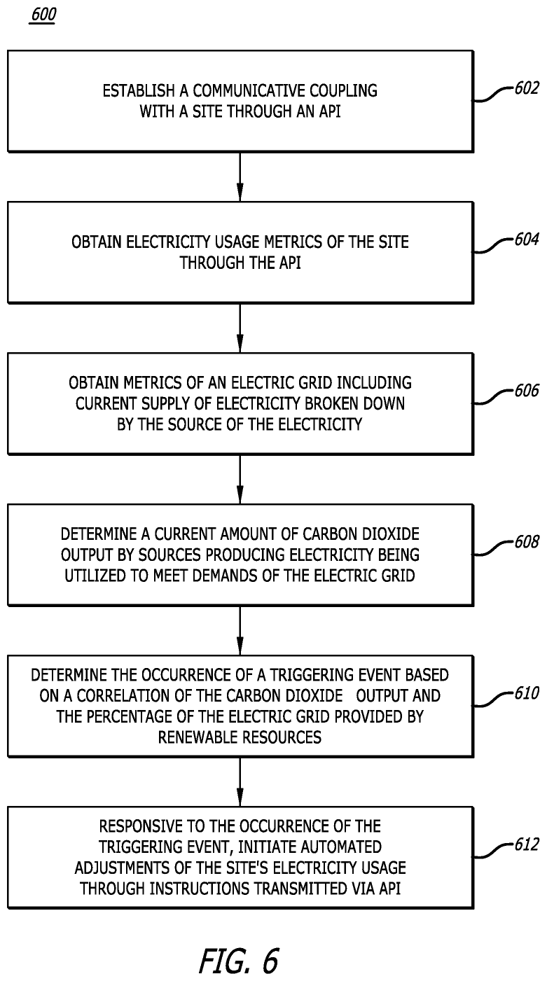

Referring to FIG. 6, a flowchart illustrating a methodology of determining the occurrence of a triggering event and initiating automated adjustment of a site's electricity usage is shown according to some embodiments. Each block illustrated in FIG. 6 represents an operation performed in the method 600 performed by the demand response system of FIG. 1. It should be understood that not every operation illustrated in FIG. 6 is required. In fact, multiple operations may be optional to complete aspects of the method 600. The discussion of the operations of method 600 may be done so with reference to any of FIGS. 1-5. Herein, the method 600 starts when a communicative coupling is established between a demand response system and a site (block 602). In some embodiments, the communicative coupling occurs via a network, such as the internet, where data is transmitted between the demand response system and the site via one or more APIs.

The method 600 continues when the demand response system obtains electricity usage metrics of the site and obtains metrics of an electrical grid that supplies power to the site (blocks 604, 606). In some embodiments, the metrics for a particular site may be obtained either via directly from a meter or an energy management system (EMS) located at the site. An EMS may automate appliances or electronic devices such as refrigerators, freezers, lights, stereo systems, HVAC systems, electric vehicle (EV) chargers, etc. Alternatively, the metrics for a particular site may be obtained from a utility company servicing the site. The metrics of a particular site may include energy usage as tracked by the utility meter at the site that is connected to the electrical grid. The energy usage may be the amount of electricity used in set intervals, e.g., 5 mins, 15 mins, 60 mins, etc.

Examples of the metrics of the electrical grid may include, but are not limited or restricted to, a current demand, current capacity indicating a supply currently available a predefined future time period such as 1-4 hours, current reserves, a forecasted peak usage for the current day, a forecasted peak for the following day, a demand trend over hours of the current day or previous day, a net demand trend indicating a demand minus wind and solar generated power provided, a resource adequacy capacity trend being a trend of energy designated by a state to be bid into the market for the reliable operation of the power grid, minus the impacts of outage derates, a 7-day resource adequacy capacity trend, a current supply provided by renewable resources (optionally broken down by renewable resource type, e.g., solar, wind), a current supply provided by non-renewable resources (optionally broken down by non-renewable resource type, e.g., natural gas, nuclear, coal), a supply trend over the hours of the current day (optionally broken down by resource type), a renewable resource trend indicating the supply of each type of renewable resource type, etc. Additionally, the demand response system may obtain metrics pertaining to emission produced as a result of generating power for the electrical grid including, but not limited or restricted to, a current amount of CO₂ emissions (mTCO₂/h) produced in generating the current supply of power, a current amount of CO₂ emissions (mTCO₂/MWh) produced in generating the current supply of power, a reduction in CO₂ emissions being a comparison of current data to the same time period in a previous year, the current CO₂ emissions broken down by resource, a total CO₂ trend being CO₂ produced over hours of the current day, the current CO₂ produced broken down by resource over hours of the current day, or a historical (e.g., yearly) CO₂ trend broken down by month. Additionally, metrics related to pricing may also be obtain, e.g., cost of utilizing power ($/MWh).

As metrics are obtained, the demand response system determines a current amount of CO₂ output produced by the power being utilized to meet the demand of the electrical grid (block 608). The current amount of CO₂ output produced by the power being utilized to meet the demand of the electrical grid may be obtained from a utility company.

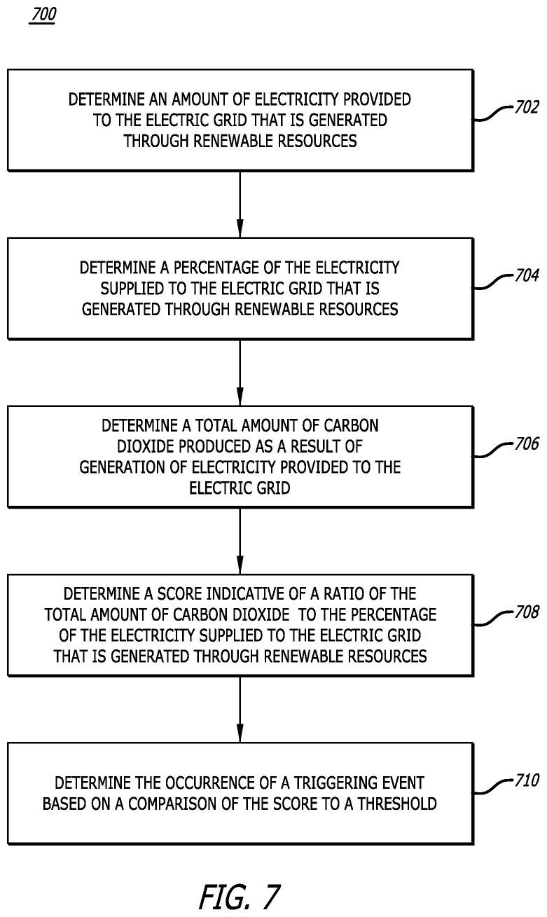

Subsequently, the demand response system determines whether a triggering event has occurred based on the comparison of (i) a predefined threshold, with (ii) a correlation between the CO₂ output and the percentage of the electrical grid supply that is generated by renewable resources (block 610). Detail as to the determination of the occurrence of a triggering event is provided below with respect to FIG. 7 and is illustrated in at least FIGS. 4A, 4B, and 7. It should be understood that the correlation may be the inverse, e.g., the CO₂ output and the percentage of the electrical grid supply that is generated by non-renewable resources.

Response to determining that a triggering event occurred, the demand response system may initiate the automate adjustment of the site's electricity usage through instructions transmitted to the site as generated by the demand response system (block 612). As noted above, the demand response system may be communicatively coupled to a site and transmit data (instructions to automate adjustment of the site's electricity usage) through one or more APIs, which may be public and/or proprietary. The instructions may be generated in accordance with predefined site-specific preferences or limitations such as, but not limited or restricted to, rules not to dim lights below a certain threshold, rules not to increase temperature on HAVC unit above a predefined temperature (at all, for more than a specified time duration, during certain hours, etc.), etc.

Some specific examples of instructions may include a date and start/stop times of a response event or a start time and duration of a response event, a signal level (0, 1, 2, 3, etc., or low, med, high, etc.) that would then correlate to some specific set of rules (e.g., increase HVAC temperature by 2 degrees Fahrenheit for level 0, increase HVAC temperature by 3 degrees Fahrenheit for level 1, etc.), and/or specific temperatures to which an HVAC system would be set or a temperature increase/decrease.

The instructions may include specific actionable items, such as dimming specific lights, changing a HVAC temperature by a specified amount or to a specified temperature, etc. Alternatively, the actionable items may be stored at each individual site such that an instruction indicates the date and timing of the response event and logic, operating on a networking device, at the site implements the actionable items in response to receipt of the instruction. In some embodiments, the instructions may be transmitted from the demand response system to an EMS located at the site. In some examples, a hardware device may be provided to a site that communicatively couples to the demand response system and one or more appliances or electronic devices at a site to receive instructions and automate actionable items within a site's curtailment strategy, e.g., acting as an energy management system or otherwise an intermediary between the appliance or electronic device and the demand response system. One example of such hardware may be a Grid Edge Module (GEM) manufactured by Enersponse, Inc., of 2901 W Coast Hwy, Newport Beach, California, 92663.

Referring now to FIG. 7, a flowchart illustrating a methodology of determining the occurrence of a triggering event is shown according to some embodiments. Each block illustrated in FIG. 7 represents an operation performed in the method 700 performed by the demand response system of FIG. 1. It should be understood that not every operation illustrated in FIG. 7 is required. In fact, multiple operations may be optional to complete aspects of the method 700. The discussion of the operations of method 700 may be done so with reference to any of FIGS. 1-6. Herein, the method 700 begins by determining an amount of electricity provided to the electrical grid that is generated through renewable resources (block 702). In some examples, such data may be obtained from one or more utility companies, where data from a plurality of utility companies may be summed. In other examples, metrics of the amount of electricity provided to the electrical grid may be provided by renewable resource type or percentage of total electricity supplied by renewable resource type. In such examples, the amount of electricity provided by each renewable resource type is summed to generate a total amount. Although the method 700 utilizes renewable resources, low CO₂ emissions resources may be utilized instead.

The method 700 continues with determining the percentage of the electricity supplied to the electric grind that is generated by renewable resources (block 704). This percentage may be determined by dividing the total amount of electricity provided by renewables by the total supply of electricity on the electrical grid (which may be obtained from one or more utility companies).

Subsequently, a total amount of CO₂ produced in generating electricity to supply the electrical grid is determined (block 706). The total amount of CO₂ produced may be obtained from one or more utility companies. Alternatively, total amount of CO₂ produced may be determined by summing the amount of CO₂ produced by each energy-generation resource currently supplying electricity to the electrical grid.

The method 700 continues with the determination of a score indicative of a ratio of the total amount of CO₂ to the percentage of the electricity supplied to the electric grid that is generated through renewable resources (block 708). In some embodiments, the score may be determined by dividing the total amount of CO₂ produced (see block 706) by the percentage of the electricity supplied to the electric grid that is generated by renewable resources (see block 704), where the percentage of the electricity supplied to the electric grind that is generated by renewable resources is first multiplied by 100. The determination of the score may be set forth in Equation 1:

$$Score = \frac{Total {CO}_{2}}{Renewable Percentage * 100} \qquad Equation 1$$

Finally, following determination of the score indicative of the ration of the total amount of CO₂ to the percentage of the electricity supplied to the electric grid that is generated by renewable resources, the score is compared to a threshold (block 710). One sample threshold comparison is illustrated in FIG. 4B.

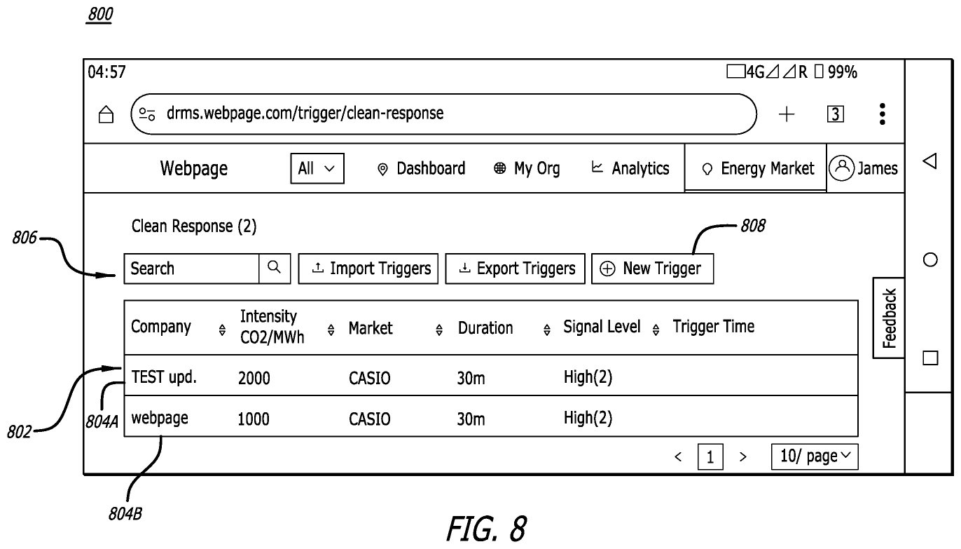

Referring now to FIG. 8, a graphical user interface illustrating metrics of energy usage on a per company basis is shown according to some embodiments. The graphical user interface (GUI) 800, or “user interface,” may be displayed on or by a network device such as on a computer monitor, a laptop screen, a mobile device screen, etc. In some embodiments, the user interface 800 may be accessible via a web browser or may be accessible via a dedicated application that is downloaded to the networking device. The user interface 800 is shown to include a main display portion that includes a listing or other illustration 802 of a set of entities (e.g., “Company”) that are communicatively coupled to the demand response system 112 as discussed above. An entity may refer an object, location, facility, etc., that utilizes a measurable amount of electricity. FIG. 8 illustratively refers to such entities as companies as shown in the header of the first column of the listing 802.

The listing 802 includes two illustrative entities 804A, 804B. The listing 802 provides metric data collected from and/or generated about each entity 804A, 804B including an entity (company) name, an intensity of CO₂/MWh, an energy market in which the entity belongs, a duration of the intensity of CO₂/MWh, and a signal level corresponding to the intensity of CO₂/MWh. The listing 802 may be sorted or filtered, either by selection of a parameter within a column header (e.g., energy market: CAISO, MISO, NYISO, etc.) or through provision of a search term in the search box 806.

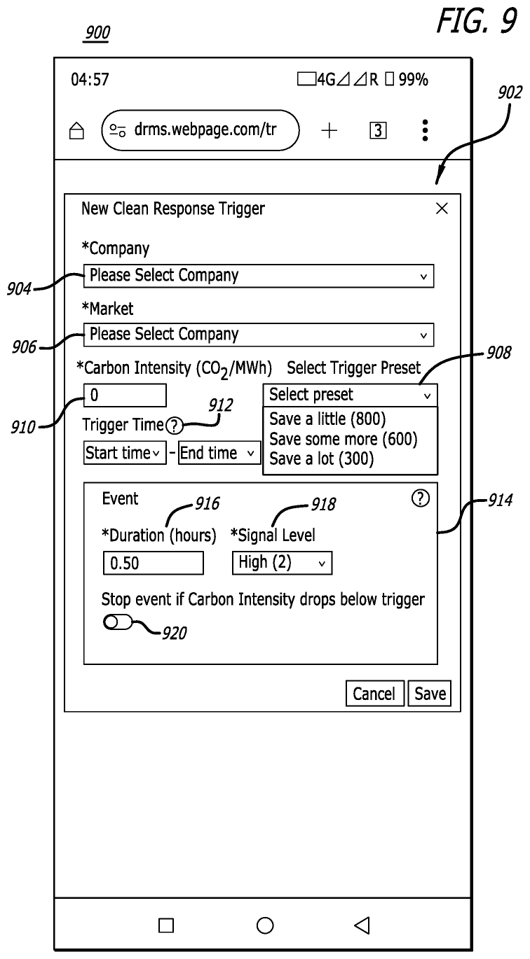

Referring to FIG. 9, a graphical user interface for receipt of user input directed to generating a new clean response event trigger of energy usage is shown according to some embodiments. As discussed above, the demand response system 112 performs operations to obtain certain information pertaining to the total amount of electricity being utilized, the amount of renewable and non-renewable energy utilized in producing the total amount of electricity being utilized, and the amount of CO₂ produced in providing the total amount of electricity being utilized to determine when a clean response event is to be triggered or initiated. A clean response event trigger may include an instance when a metric as determined by the clean response system 114 meets or exceeds a particular threshold, where, for example, the threshold may represent a ratio of CO₂ output to electricity supplied to the electrical grid produced by renewable resources.

One or more clean response event triggers may be associated with each entity communicatively coupled with the demand response system 112. FIG. 9 illustrates a graphical user interface (GUI) 900 or “user interface” that is configured to receive user input such that the demand response system 112 generates a new clean response event trigger based on the received user input. The user interface 900 includes a display screen (e.g., a pop-up) 902 that includes user input (UI) elements such as dropdown selection boxes 904, 906 configured to receive selection of an entity (company) and an energy market, respectively. The display screen 902 also includes a dropdown selection box 608 configured to receive a selection of a trigger preset option (e.g., how much carbon to save), a text box 910 configured to receive a carbon intensity value (e.g., the threshold for triggering the event), and an event display portion 914 that includes particulars of the event that is to occur upon the triggering including a duration of the event and a signal level of the event, UI elements 916, 918, respectively. Additionally, a UI element 920 may be a toggle switch that enables the automated termination of the event when the carbon intensity of the grid falls below the value provided in the text box 910.

While some particular embodiments have been disclosed herein, and while the particular embodiments have been disclosed in some detail, it is not the intention for the particular embodiments to limit the scope of the concepts provided herein. Additional adaptations and/or modifications can appear to those of ordinary skill in the art, and, in broader aspects, these adaptations and/or modifications are encompassed as well. Accordingly, departures may be made from the particular embodiments disclosed herein without departing from the scope of the concepts provided herein.

What is claimed is:

1. A computerized method comprising:
obtaining electrical grid metrics;
obtaining electricity usage metrics from one or more sites;
determining a clean response score indicative of a ratio of a total amount of carbon dioxide (CO₂) produced as a result of generation of electricity provided to the electrical grid and a percentage of the electricity supplied to the electrical grid that is generated using low CO₂ emissions resources, wherein low CO₂ emissions resources include renewable resources and nucelar resources;
performing a threshold comparison operation with the clean response score to a threshold; and
based on a result of the threshold comparison operation, automating the initiation of a curtailment strategy at a first site, wherein the curtailment strategy includes operations resulting in a reduction of electricity usage by the first site.

2. The computerized method of claim 1, wherein the one or more sites include a residential building, a commercial building, an industrial building, an agriculture site, a water treatment plant, or a waste treatment plant.

3. The computerized method of claim 1, wherein automating the initiation of the curtailment strategy at the first site includes:
generating instructions that, when executed by one or more processors, cause adjustment of a functioning of an electrical device resulting in the reduction of the electricity usage by the first site, and
transmitting the instructions to the first site.

4. The computerized method of claim 3, wherein the instructions are transmitted to one of a supervisory control and data acquisition (SCADA) control system, an energy management system (EMS), or a building management system (BMS) at the first site.

5. The computerized method of claim 3, wherein the curtailment strategy specified for the first site is a first curtailment strategy, and further comprising:
automating initiation of a second curtailment strategy at a second site, wherein the second curtailment strategy includes second operations resulting in a reduction of electricity usage by the second site, wherein the second curtailment strategy is different than the first curtailment strategy.

6. The computerized method of claim 1, further comprising:
prior to automating the initiation of the curtailment strategy at a first site, initiating a preemptive response event, wherein the preemptive response event includes operations resulting in an increase of the electricity usage by the first site prior to initiation of the curtailment strategy.

7. The computerized method of claim 1, wherein determining the clean response score is performed by one or more logic modules operating in a computing environment, wherein the one or more logic modules establish communicatively couplings with one or more utility companies and the one or more sites through one or more application programming interfaces (APIs) thereby exchanging data therebetween.

8. A computing device, comprising:
a processor; and
a non-transitory computer-readable medium having stored thereon instructions that, when executed by the processor, cause the processor to perform operations including:
obtaining electrical grid metrics;
obtaining electricity usage metrics from one or more sites;
determining a clean response score indicative of a ratio of a total amount of carbon dioxide (CO₂) produced as a result of generation of electricity provided to the electrical grid and a percentage of the electricity supplied to the electrical grid that is generated using low CO₂ emissions resources, wherein low CO₂ emissions resources include renewable resources and nucelar resources;
performing a threshold comparison operation with the clean response score to a threshold; and
based on a result of the threshold comparison operation, automating the initiation of a curtailment strategy at a first site, wherein the curtailment strategy includes operations resulting in a reduction of electricity usage by the first site.

9. The computing device of claim 8, wherein the one or more sites include a residential building, a commercial building, an industrial building, an agriculture site, a water treatment plant, or a waste treatment plant.

10. The computing device of claim 8, wherein automating the initiation of the curtailment strategy at the first site includes:
generating instructions that, when executed by one or more processors, cause adjustment of a functioning of an electrical device resulting in the reduction of the electricity usage by the first site, and
transmitting the instructions to the first site.

11. The computing device of claim 10, wherein the instructions are transmitted to one of a supervisory control and data acquisition (SCADA) control system, an energy management system (EMS), or a building management system (BMS) at the first site.

12. The computing device of claim 10, wherein the curtailment strategy specified for the first site is a first curtailment strategy, and wherein the operations further include:
automating initiation of a second curtailment strategy at a second site, wherein the second curtailment strategy includes second operations resulting in a reduction of electricity usage by the second site, wherein the second curtailment strategy is different than the first curtailment strategy.

13. The computing device of claim 8, wherein the operations further include:
prior to automating the initiation of the curtailment strategy at a first site, initiating a preemptive response event, wherein the preemptive response event includes operations resulting in an increase of the electricity usage by the first site prior to initiation of the curtailment strategy.

14. The computing device of claim 8, wherein determining the clean response score is performed by one or more logic modules operating in a computing environment, wherein the one or more logic modules establish communicatively couplings with one or more utility companies and the one or more sites through one or more application programming interfaces (APIs) thereby exchanging data therebetween.

15. A non-transitory computer-readable medium having stored thereon instructions that, when executed by one or more processors, cause the one or more processor to perform operations including:
obtaining electrical grid metrics;
obtaining electricity usage metrics from one or more sites;
determining a clean response score indicative of a ratio of a total amount of carbon dioxide (CO₂) produced as a result of generation of electricity provided to the electrical grid and a percentage of the electricity supplied to the electrical grid that is generated using low CO₂ emissions resources, wherein low CO₂ emissions resources include renewable resources and nucelar resources;
performing a threshold comparison operation with the clean response score to a threshold; and
based on a result of the threshold comparison operation, automating the initiation of a curtailment strategy at a first site, wherein the curtailment strategy includes operations resulting in a reduction of electricity usage by the first site.

16. The non-transitory computer-readable medium of claim 15, wherein the one or more sites include a residential building, a commercial building, an industrial building, an agriculture site, a water treatment plant, or a waste treatment plant.

17. The non-transitory computer-readable medium of claim 15, wherein automating the initiation of the curtailment strategy at the first site includes:
generating instructions that, when executed by one or more processors, cause adjustment of a functioning of an electrical device resulting in the reduction of the electricity usage by the first site, and
transmitting the instructions to the first site, and wherein the instructions are transmitted to one of a supervisory control and data acquisition (SCADA) control system, an energy management system (EMS), or a building management system (BMS) at the first site.

18. The non-transitory computer-readable medium of claim 17, wherein the curtailment strategy specified for the first site is a first curtailment strategy, and wherein the operations further include:
automating initiation of a second curtailment strategy at a second site, wherein the second curtailment strategy includes second operations resulting in a reduction of electricity usage by the second site, wherein the second curtailment strategy is different than the first curtailment strategy.

19. The non-transitory computer-readable medium of claim 15, wherein the operations further include:
prior to automating the initiation of the curtailment strategy at a first site, initiating a preemptive response event, wherein the preemptive response event includes operations resulting in an increase of the electricity usage by the first site prior to initiation of the curtailment strategy.

20. The non-transitory computer-readable medium of claim 15, wherein determining the clean response score is performed by one or more logic modules operating in a computing environment, wherein the one or more logic modules establish communicatively couplings with one or more utility companies and the one or more sites through one or more application programming interfaces (APIs) thereby exchanging data therebetween.
